(19) United States
(12) Patent Application Publication
(10) Pub. No.: US 2008/0295715 A1
(43) Pub. Date: Dec. 4, 2008

(54) Apparatus for introducing sheet into sheet-fed printing press

(75) Inventor: Shizuo Masuda, Shizuoka (JP)

Correspondence Address: Ladas & Parry, 26 West 61st Street, New York, NY, 10023, US

(73) Assignee: SHINOHARA MACHINERY CO ., LTD.

(21) Appl. No.: 12/154,862

(22) Filed: May 28, 2008

(30) Foreign Application Priority Data
May 29, 2007 (JP) 2007-141701

(51) Int. Cl. B41F 13/24

(52) U.S. Cl. 101/232

(57) ABSTRACT

Apparatus for introducing sheet is disclosed which mainly aims at feeding sheet smoothly into sheet-fed printing press even in case of thick sheet with higher resilient force. The present invention premises sheet-fed printing press with a plurality of printing units whose sheet transfer path is composed of double-sized transfer and impression cylinders 20, 18. Sheet introducing apparatus comprises: first transfer cylinder 30 of approximately the same construction with said double-sized transfer cylinder 20 and is disposed between sheet feeder 26 and first printing unit 10a, the center of rotation 34 being above feeding path for sheet 22, and second transfer cylinder 32 of also approximately the same construction with said double-sized impression cylinder 18 and is in contact with the lower portion of said first transfer cylinder 30 and said transfer cylinder 20 of said first printing unit 10a.

### BACKGROUND OF THE INVENTION

1. Field of the Invention

The present invention relates generally to sheet-fed printing press, or more precisely, to apparatus for introducing sheet smoothly into printing unit even in case of thick sheet.

2. Description of the Prior Art

In sheet-fed printing press by which each color is continuously layered onto standard-size sheet, parts manufacturing as well as construction can remarkably be simplified if printing units for each color are in simple modular construction, thereby manufacturing cost will satisfactorily be reduced.

In Japanese patent laid-open No. 2006-289974, sheet-fed printing press for offset printing is disclosed in which each printing unit is standardized in a modular fashion with plate cylinder, blanket cylinder, impression cylinder and double-sized transfer cylinder. But, the prior art does not take into account of thick sheet with higher resilient force against bending force, therefore no consideration is taken with regard to feeding piled sheet from feeder unit into first printing unit.

### SUMMARY OF THE INVENTION

Upon consideration of above-described problem of prior art techniques, apparatus for introducing sheet according to the present invention aims at feeding sheet smoothly into printing unit even in case of thick sheet with higher resilient force. The present invention also aims at modularization as well as common use of, not only printing units itself, but also the parts for sheet introducing apparatus. The present invention further aims at making most of the space for pre-printing treatment.

To achieve these objects, sheet introducing apparatus according to the present invention premises sheet-fed printing press with a plurality of printing units whose sheet transfer path is composed of double-sized transfer and impression cylinders, and comprising first transfer cylinder of approximately the same construction with the double-sized transfer cylinder and is disposed between sheet feeder and the first printing unit, the center of rotation being above the sheet feeding path, and second transfer cylinder of also approximately the same construction with the double-sized impression cylinder and is in contact with the lower portion of the first transfer cylinder and the transfer cylinder of the first printing unit.

By these constructions, total cost of manufacturing the sheet-fed printing press can satisfactorily be reduced. Even the thick sheet can be fed into the first printing without any problems. Further, the sheet introducing apparatus is suitable for pre-printing treatment, thereby total value of usefulness can be raised.

The above and other objects of the invention will become apparent from the following description of preferred embodiment taken in conjunction with the accompanying drawings. However, the following description is only an embodiment of the invention and the present invention is not limited to the embodiment.

### BRIEF DESCRIPTION OF THE DRAWINGS

FIG. 1 is a side view partly showing a sheet-fed printing press equipped with an apparatus for introducing sheet according to the present invention.

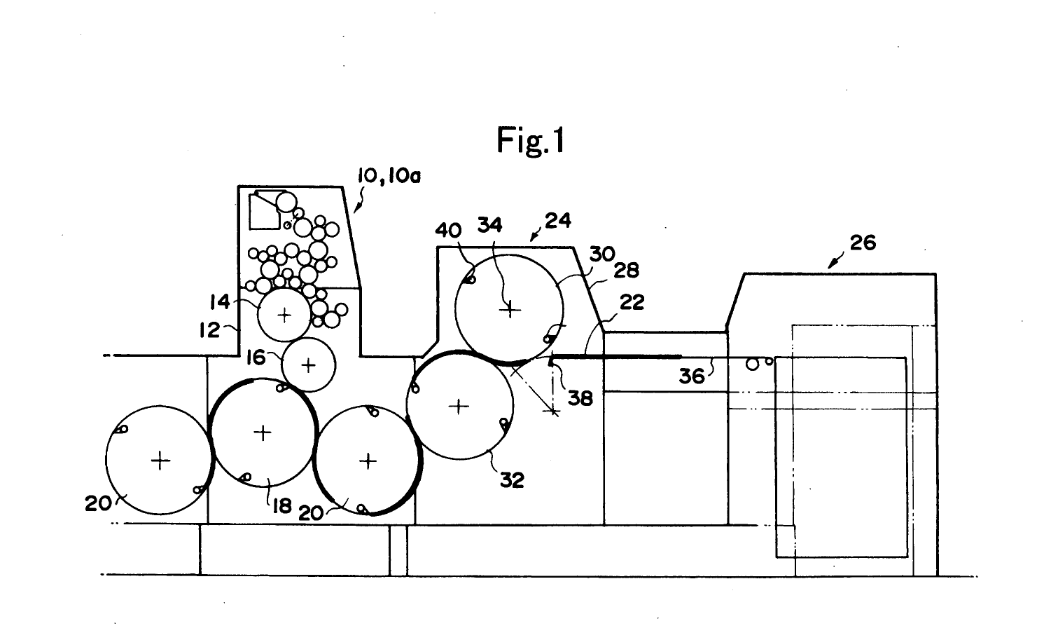

FIG. 2 shows a single module of printing unit for the premise of the present invention.

FIG. 3 is a side view showing an embodiment in which corona discharge device is provided in the apparatus for introducing sheet.

FIG. 4 is also a side view showing another embodiment in which seasoning device is opposed to the apparatus for introducing sheet.

### DESCRIPTION OF THE PREFERRED EMBODIMENT

An embodiment of sheet introducing apparatus according to the present invention will be detailed herein-under with reference to the accompanying drawings.

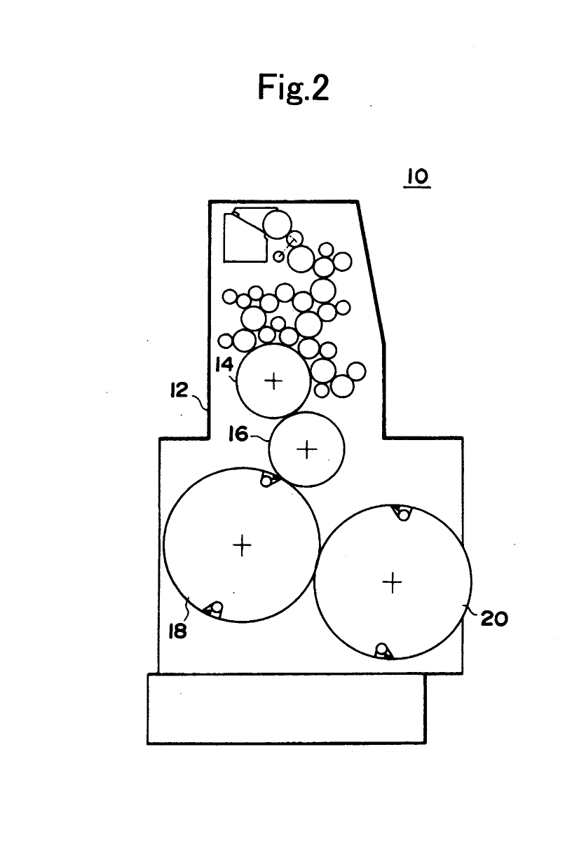

In sheet-fed printing press for continuously layering each color of black, cyan, magenta and yellow onto standard-size sheet, each printing unit 10 is, as shown in FIG. 2, independently prepared in standard modular fashion and side frames 12 on both sides of machine are coupled each other.

As is well known in the art, plate cylinder 14, blanket cylinder 16 and double-sized impression cylinder 18 are rotatably supported between both side frames 12 and sheet transfer path is composed by linking printing units 10 with double-sized transfer cylinder 20.

As is commonly used in the field of printing machinery, the term “double-sized” means that cylinder has a diameter twice that of plate cylinder 14. Delivery device for re-piling printed sheet 22 is prepared at downstream in succession to printing units 10, but such device is not shown in the figures, as the present invention solely relates to sheet introducing apparatus 24 at upstream.

Sheet introducing apparatus 24 according to the present invention is in itself a single unit disposed between sheet feeder 26 on which sheet 22 to be printed is piled and first printing unit (especially designated by reference numeral 10a). Likewise each printing unit 10, first and second transfer cylinders 30, 32 are rotatably supported by a pair of side frames 28.

First transfer cylinder 30 has approximately the same construction as double-sized transfer cylinder 20 of printing unit 10 and its center of rotation 34 is, as shown in the figure, above feeding path for sheet 22. The words ” approximately the same” means that substantial construction of cylinders is per se the same. Feeding path for sheet 22 means the route that the piled sheet 22 is transported from sheet feeder 26 onto feeder board 36 in shingle-like manner. Then, sheet 22 is gripped by swing gripper 38 without suffering severe bending force and taken up by gripper 40 of first transfer cylinder 30. Second transfer cylinder 32 has also approximately the same construction as double-sized impression cylinder 18 of printing unit 10 and is in contact with the lower portion of first transfer cylinder 30 and double-sized transfer cylinder 20 of first printing unit 10a in order to transport sheet 22. Consequently, all path for sheet transfer is entirely composed of double-sized cylinders, thereby reducing bending force which is troublesome for thick sheet to the utmost.

It is surely very useful to dispose sheet introducing apparatus 24 in modular fashion between feeder device 26 and first printing unit 10a from the standpoint to prevent bad influence on thick sheet due to its resilient force, but, on the other hand, surplus space is inevitably originated by such construction. So, it is very important to make full use of such surplus space in order to raise use-value of printing press.

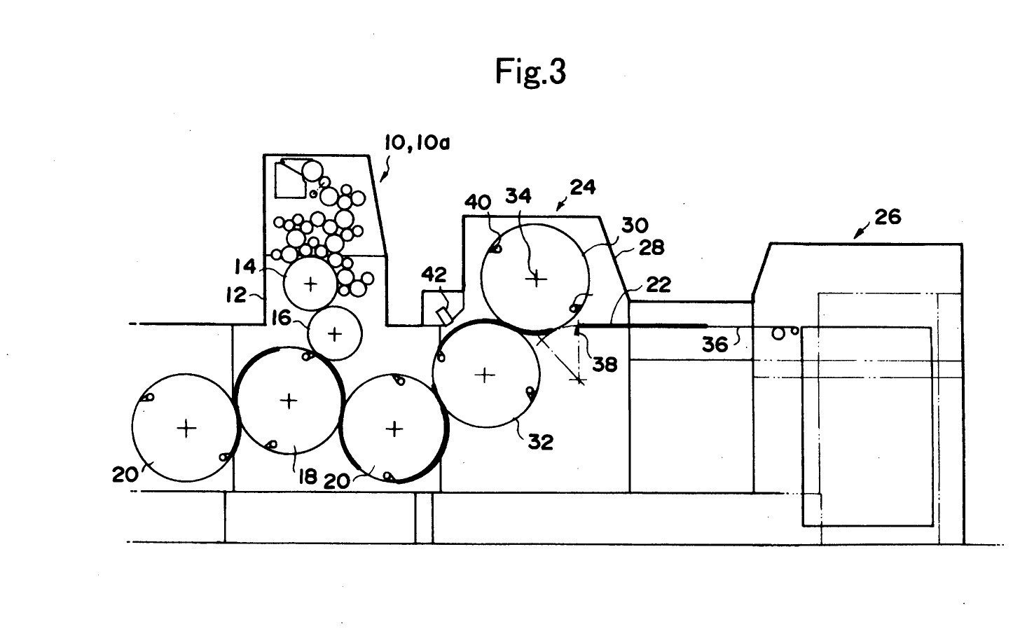

Accordingly, in an embodiment shown in FIG. 3, corona discharge device 42 is located in opposite to second transfer cylinder 32. Such device 42 performs surface treatment on sheet 22 (for example, film) to be printed in order to improve fixing of ink as pre-printing treatment. The detail of such surface treatment is described, for example, in Japanese patent laid-open No. 2007-50692.

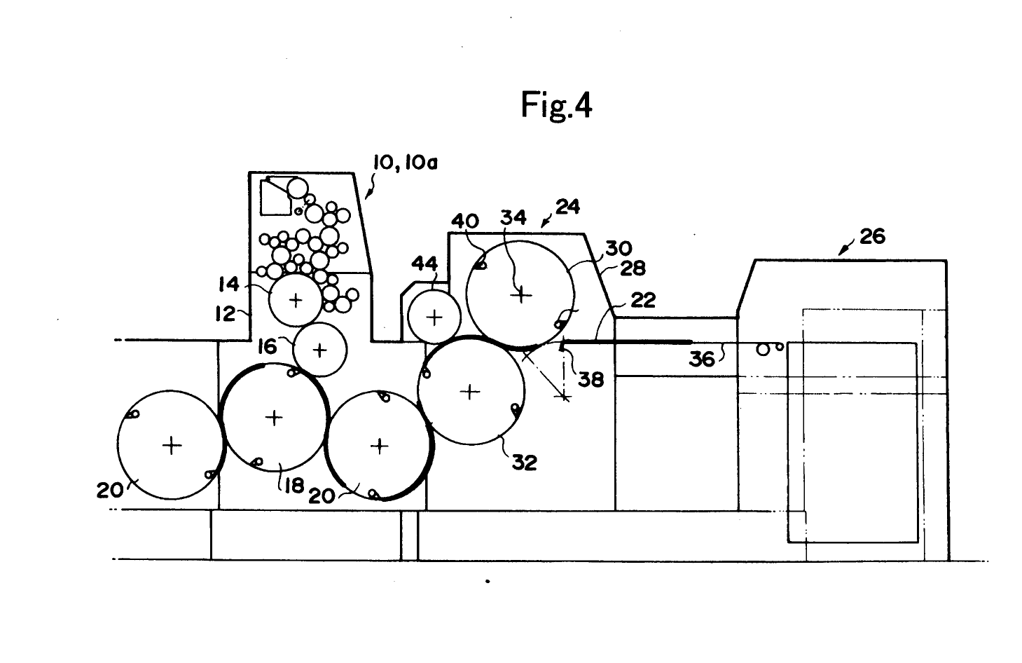

In other embodiment shown in FIG. 4, seasoning device 44 is provided in contact with second transfer cylinder 32. In case sheet 22 to be printed is, for example, corrugated board, high amount of expansion during printing is naturally anticipated. So, seasoning device 44 (with its blanket surface) presses sheet 22 just before printing and, at the same time, gets rid of paper dust and so forth.

Manufacturing cost can apparently be reduced through common use of parts with printing unit in modular fashion by sheet introducing apparatus according to the present invention. Additionally, thick sheet can smoothly be printed, as sheet transfer path is entirely composed of double-sized cylinders. Furthermore, surplus space can be made full use for pre-printing treatment. In conclusion, use-value of sheet-fed printing press can greatly be raised.

The present invention is not limited to the embodiment described above; it can be extended and modified variously.

### DESCRIPTION OF THE REFERENCE NUMERALS

10 printing unit

10a first printing unit

18 impression cylinder

20 transfer cylinder

22 sheet

24 apparatus for introducing sheet

26 sheet feeder

30 first transfer cylinder

32 second transfer cylinder

34 center of rotation

42 corona discharge device

44 seasoning device

What is claimed is:

1. In a sheet-fed printing press whose sheet transfer path for a plurality of printing units 10 in modular fashion is composed of double-sized transfer and impression cylinders 20, 18;
Apparatus for introducing sheet into said sheet-fed printing press comprising:
First transfer cylinder 30 of approximately the same construction with said double-sized transfer cylinder 20 and is disposed between sheet feeder 26 and first printing unit 10a, the center of rotation 34 being above feeding path for sheet 22,
Second transfer cylinder 32 of also approximately the same construction with said double-sized impression cylinder 18 and is in contact with the lower portion of said first transfer cylinder 30 and said transfer cylinder 20 of said first printing unit 10a.

2. Apparatus for introducing sheet according to claim 1, wherein corona discharge device 42 is opposed to said second transfer cylinder 32.

3. Apparatus for introducing sheet according to claim 1, wherein seasoning device 44 is provided in contact with said second transfer cylinder 32.
